(19) United States
(12) Patent Application Publication
(10) Pub. No.: US 2014/0342897 A1
(43) Pub. Date: Nov. 20, 2014

(54) Glass Articles/Materials For Use As Touchscreen Substrates

(71) Applicant: Corning Incorporated, Corning, NY (US)

(72) Inventors: Jaymin Amin, Corning, NY (US); Adam James Ellison, Painted Post, NY (US); Gregory Scott Glaesemann, Corning, NY (US); Timothy Michael Gross, Waverly, NY (US)

(73) Assignee: Corning Incorporated, Corning, NY (US)

(21) Appl. No.: 14/448,143

(22) Filed: Jul. 31, 2014

Related U.S. Application Data
(62) Division of application No. 13/291,567, filed on Nov. 8, 2011.
(60) Provisional application No. 61/418,019, filed on Nov. 30, 2010.

(51) Int. Cl. C03C 3/091

(52) U.S. Cl. CPC C03C 3/091
USPC 501/66; 501/53

(57) ABSTRACT

The present disclosure relates to glass articles for use as a touchscreen substrate for use in a portable electronic device, particularly comprising an alkali-free aluminosilicate glass exhibiting a high damage threshold of at least 1000 gf, as measured by the lack of the presence of median/radial cracks when a load is applied to the glass using a Vickers indenter, a scratch resistance of at least 900 gf, as measured by the lack of the presence of lateral cracks when a load is applied by a moving Knoop indenter and a linear coefficient of thermal expansion (CTE) over the temperature range 0-300° C. which satisfies the relationship: 25×10-7/° C.≦CTE≦40×10-7/° C.

### CROSS REFERENCE TO RELATED APPLICATIONS

The present application is a divisional of U.S. Non-provisional patent application Ser. No. 13/291,567 entitled “Glass Articles/Materials for Use as Touchscreen Substrates,” filed Nov. 8, 2011 which claims priority to U.S. Provisional Patent Application Ser. No. 61/418,019, filed Nov. 30, 2010 entitled “Glass Articles/Materials for Use as Touchscreen Substrates,” each of which is incorporated by reference herein.

### TECHNICAL FIELD

The invention is directed to glass materials that can be used as durable touchscreen substrates for use in portable electronic devices. In particular, the invention is directed to an alkali-free aluminosilcate article having high scratch and damage resistance which can be used as a touchscreen substrate for use in portable electronic devices.

### BACKGROUND

Touchscreens have become increasingly prevalent in mobile handset devices, such as cellular phones, MP3 players, mobile internet devices (MIDs) and the like, and are now beginning to find applications in larger form factors in consumer electronics, such as laptop notebooks and desktop PCs. They are typically used as input devices for operations in a computing system, and offer ease and versatility of use by allowing selections to be made through the touch, or proximity, of a finger. Touchscreens have typically been of the resistive nature; however, in handheld applications, capacitive touchscreens are becoming a feature-of-choice, allowing for the use of multi-touch sensors.

Touchscreens typically are made through the deposition of single or multiple layers of indium tin oxide (ITO) on a transparent substrate that is either placed over a display panel or integrated to a display panel. For consumer electronics applications, such as mobile handsets, the transparent substrate is typically glass, and, depending upon the mechanical strength requirements for the application, the glass is chemically strengthened prior to ITO processing. For capacitive touchscreens, the trend has been to move to thin (<1 mm thick) glass substrates with ITO deposited and designed in rows and columns on the top and bottom faces of the glass (referred to as double-side ITO glass). The typical glass used is soda lime. The glass is typically chemically strengthened in sheet form to a very shallow depth-of-layer (case depth) of the order of a few microns, such that it allows for cutting of the glass into smaller pieces, after the ITO and any other required thin film materials have been deposited and patterned on one or both of the glass, that can then be integrated into the final device structure. The glass pieces when cut to size therefore have a ‘lightly’ chem.-strengthened surface and edges which are chemstrengthened only at the tops and bottom, with the bulk of the edges being non-strengthened and under tension. Typically the ITO coated glass is protected by a cover lens, which could be some plastic material or, in an exemplary embodiment, a chemically strengthened glass. The cover lens, and surrounding bezel, as well as the rest of the enclosure, serve to protect the ITO glass and display unit from scratches and other mechanical issues.

In current embodiments of the ITO glass, the glass is chem-tempered so as to make it stronger and more damage resistant, whilst still allowing for the glass to be laser cut, as mentioned above. Chem-tempering requires the initial glass to contain alkali ions. Processing of ITO and other thin films on chemically strengthened glass has to be done at temperatures significantly lower than the ion-exchange temperature, in order to ensure that the stress imparted by the ion-exchange does not relax and cause a longer term strength issue in the glass. In addition, the glass may require a barrier layer prior to deposition of the ITO, since any outdiffusion of alkali ions over time can impact the performance of the ITO.

In view of the foregoing problems with current alkali-containing touchscreen substrate materials, there is a need for improved glass substrate materials for portable computing device touchscreen substrates. In particular, there is a need for glass substrate materials which are can be made thinner, stronger, more damage and scratch resistant than current chem-tempered glass materials, without having to subject the glass to any strengthening process.

### SUMMARY

Disclosed herein is an alkali-free aluminosilicate glass article which exhibits improved damage and scratch resistance and is particularly suitable for use as a touchscreen substrate for use in portable electronics.

In one embodiment the glass article is for use as a touchscreen substrate in a portable electronic device, the article comprising an alkali-free aluminosilicate glass exhibiting a high damage threshold of at least 1000 gf, as measured by the lack of the presence of median/radial cracks when a load is applied to the glass using a Vickers indenter, a scratch resistance of at least 900 gf, as measured by the lack of the presence of lateral cracks when a load is applied by a moving Knoop indenter. The glass material further exhibits certain properties which render it particularly suitable for use as the electronic device touchscreen substrate including a linear coefficient of thermal expansion (CTE) over the temperature range 0-300° C. which satisfies the relationship: 25×10-7/° C.≦CTE≦40×10-7/° C.

The alkali-free aluminosilicate glass touchscreen substrate disclosed herein can be used in a variety of consumer electronic articles, for example, cellphones and other electronic devices such as music players, notebook computers, PDA's, game controllers, electronic book readers and other devices requiring touchscreen capability.

### DETAILED DESCRIPTION

As is described herein below, the needs of the industry for more damage and scratch resistant, thinner touchscreen substrate are met by the use of durable alkali-free aluminosilicate glass articles as the touchscreen substrate for consumer electronics, for example, cell phones, music players, notebook computers, game controllers, electronic book readers and other devices. These glass materials possess certain advantages such as improved damage and scratch and improved edge strength over the presently used soda lime glass materials used as the touchscreen materials.

As used herein the terms ‘touchscreen” is used to refer to touchscreens of all kinds but in particular capacitive including multi-touch sensors touchscreens for use with portable, as well as non-portable consumer electronic devices. In particular, the term includes those touchscreens which are made through the deposition of single or multiple layers of indium tin oxide (ITO) on a transparent substrate that is either placed over a display panel or integrated to a display panel.

The glass material for use as a touchscreen substrate for use in a portable electronic device is comprised of an alkali-free aluminosilicate glass, due to the fact that these glasses generally possess sufficient chemical and mechanical durability to withstand consumer uses and applications. The alkali-free glass material selected generally depends on many factors including but not limited to damage resistance, scratch resistance, edge strength and linear coefficient of thermal expansion.

In one particular embodiment the glass article for use as a touchscreen substrate for use in a portable electronic device, comprises an alkali-free aluminosilicate glass exhibiting a high damage threshold of at least 1000 gf, as measured by the lack of the presence of median/radial cracks when a load is applied to the glass using a Vickers indenter, a scratch resistance of at least 900 gf, as measured by the lack of the presence of lateral cracks when a load is applied by a moving Knoop indenter. The glass material further exhibits certain properties which render it particularly suitable for use as the electronic device touchscreen substrate including a linear coefficient of thermal expansion (CTE) over the temperature range 0-300° C. which satisfies the relationship: 25×10-7/° C.≦CTE≦40×10-7/° C.

High damage threshold, defined as the lack of median/radial cracks up to applied loads of 1000 gf, can be measured using a Vickers indenter. Although there is no standard ASTM method for the Vickers indenter test, a useful testing method is described in articles by R. Tandon et al., “Surface Stress Effects on Indentation Fracture Sequences,” J. Am. Ceram Soc. 73 [9] 2619-2627 (1990); R. Tandon et al., “Indentation Behavior of Ion-Exchanged Glasses,” J. Am. Ceram Soc. 73 [4] 970-077 (1990); and P. H. Kobrin et al., “The Effects of Thin Compressive Films on Indentation Fracture Toughness Measurements,” J. Mater. Sci. 24 [4] 1363-1367 (1989)]. Chem-tempered/strengthened SLS glasses tend to exhibit median/radial cracking at applied load levels in the range of applied load less than 1000 gf, and in most cases, loads of less than 800 gf. As mentioned above, the alkali-free non-strengthened glass articles of the present disclosure generally exhibit the lack of the presence of radial cracks up to applied loads of 1000 gf and in further embodiments at loads of up to 1500 gf, and in still further embodiments up to 2000 gf.

Scratch resistance or lateral crack threshold is measured using ASTM G171-03 scratch test method and the Micro-Tribometer mod.UMT-2. The UMT is a commercial instrument (CETR Inc., Campbell, Calif.) that permits various form of tribological testing including scratch tests. An appropriate reference is V. Le Houerou et al., “Surface Damage of Soda-lime-silica Glasses: Indentation Scratch Behavior,” J. Non-Cryst Solids, 316 [1] 54-63 (2003). In this test, a Knoop indenter is dragged across the surface with an ever increasing indentation load to a maximum load of 500 grams in approximately 100 seconds (so as to distinguish glass-to-glass differences). Chem-tempered/strengthened SLS glasses tend to exhibit lateral cracking at applied load levels in the range of applied load less than 500 gf, and in most cases, loads of less than 200 gf. As mentioned above, the alkali-free non-strengthened glass articles of the present disclosure generally exhibit the lack of the presence of lateral cracks up to applied loads of 1000 gf and in further embodiments at loads of up to 1600 gf.

This requisite high damage threshold (no median/radial cracks up to loads of 1000 gf) and scratch resistance (lack of lateral cracking up to loads of 900 gf) function to result in a touchscreen substrate which is sufficiently strong and durable so as to withstand typical consumer use/applications. In short, the alkali-free aluminosilicate glass substrates of the present embodiments provide substrates which exhibit a higher degree of scratch and damage resistance when compared to SLS glasses and thus would be highly beneficial for applications as an ITO or DITO glass for touchscreens, particularly where mechanical reliability is of essence.

Other advantages of using an alkali-free glass for the touchscreen substrate, particularly when compared to industry standard and currently utilized soda lime silicate (SLS) glasses, include the following (1)
It is not necessary to strengthen these glasses due to their inherent damage and scratch resistance, and therefore these glasses can be processed as full sheets and then laser cut without resultant warp typically seen when ion-exchanged SLS glasses are laser cut SLS;
The use of alkali-free aluminosilicate glasses which are formed using a down-draw process allows for the use of pristine thin glass (0.1-1 mm thick) whereas SLS glasses typically would require polishing to achieve these thinner specifications;
The lack of an ion-exchange process implies that processing temperatures can be higher than in ion-exchange glass, as ion-exchanged glasses need to be processed below the exchange temperature in order to ensure minimal ion mobility and resulting change in strength.
The disclosed alkali-free aluminosilicate touchscreen glass substrate exhibit which closely matched typical display glass, which in turn allows for a future hybrid integration of the ITO glass with the display glass;
The lack of ion-exchange implies edges that are uniform and not partially in compression and partially in tension, which should be contrasted with the characteristics of SLS glasses which when cut to size exhibit edges which are chemstrengthened only at the tops and bottom, with the bulk of the edges being non-strengthened and under tension. As a result, the alkali-free aluminosilicate touchscreen substrates are not prone to delayed failure from fatigue effects in the glass which is typically present in those substrates which have exposed edges under tension, and which will result in a reduction in strength of the edges with time. These delayed fatigue effects are likely correlated to the temperature or humidity or a combination thereof that the glass may be exposed to.

As mentioned hereinabove, the glass materials for use as electronic device touchscreen substrates comprises an alkali-free aluminosilicate glass material due to their sufficient durability and mechanical properties, particularly when compared to SLS glass based touchscreen substrates.

A first representative alkali-free alkali aluminosilicate glass compositional family, from which suitable compositions for use in the present embodiments can be found, comprises in mole percent on an oxide basis:
SiO₂: 64.0-71.0
Al₂O₃: 9.0-12.0
B₂O₃: 7.0-12.0
MgO: 1.0-3.0
CaO: 6.0-11.5
SrO: 0-2.0 (preferably 0-1.0)
BaO: 0-0.1
wherein:
   (a) 1.00≦Σ[RO]/[Al₂O₃]≦1.25 (preferably, 1.03≦Σ[RO]/[Al₂O₃]≦1.12), where [Al₂O₃] is the mole percent of Al₂O₃ and Σ[RO] equals the sum of the mole percents of MgO, CaO, SrO, and BaO; and
   (b) the glass has at least one (and preferably both) of the following compositional characteristics: (i) on an oxide basis, the glass comprises at most 0.05 mole percent Sb₂O3; (ii) on an oxide basis, the glass comprises at least 0.01 mole percent SnO₂.

Preferably, the glass has the further compositional characteristic that on an oxide basis, the glass comprises at most 0.05 mole percent As₂O₃.

A second representative alkali-free aluminosilicate glass composition range from which touchscreen substrate articles can be fabricated, comprises, in mole percent on an oxide basis, the following:
SiO₂: 64.0-71.0
Al₂O₃: 9.0-12.0
B₂O₃: 7.0-12.0
MgO: 1.0-3.0
CaO: 6.0-11.5
SrO: 0-1.0
BaO: 0-0.1
wherein: Σ[RO]/[Al₂O₃]≧1.00 (preferably, Σ[RO]/[Al₂O₃]≧1.03).

Preferably, the Σ[RO]/[Al₂O₃] ratio is less than or equal to 1.25 (more preferably, less than or equal to 1.12). Also, the glass preferably has at least one (more preferably, all) of the following compositional characteristics:
(a) on an oxide basis, the glass comprises at most 0.05 mole percent As₂O₃;
(b) on an oxide basis, the glass comprises at most 0.05 mole percent Sb₂O₃;
(c) on an oxide basis, the glass comprises at least 0.01 mole percent SnO₂.

A third representative alkali-free aluminosilicate glass composition range and method from which touchscreen substrate articles can be fabricated is as follows. In accordance with this third aspect, provided is a method for producing alkali-free aluminosilicate glass sheets (which can be subsequently cut to form touchscreen substrates) by a downdraw process (e.g., a fusion process) comprising selecting, melting, and fining batch materials so that the glass making up the sheets comprises SiO₂, Al₂O₃, B₂O₃, MgO, and CaO, and, on an oxide basis, has:
(i) a Σ[RO]/[Al₂O₃] ratio greater than or equal to 1.0; and
(ii) a MgO content greater than or equal to 1.0 mole percent (and preferably less than or equal to 3.0 mole percent);
wherein:
   (a) the fining is performed without the use of substantial amounts of either arsenic or antimony (i.e., the concentrations of As₂O₃ and Sb₂O₃ are each less than or equal to 0.05 mole percent); and
   (b) a population of 50 sequential glass sheets produced by the downdraw process from the melted and fined batch materials has an average gaseous inclusion level of less than 0.05 gaseous inclusions/cubic centimeter, where each sheet in the population has a volume of at least 500 cubic centimeters.

Preferably, the glass making up the sheet is also substantially free of BaO (i.e., the concentration of BaO is less than or equal to 0.05 mole percent). Also, SnO₂ is preferably used in the fining.

In accordance with each of the foregoing aspects disclosed, the glass preferably has some and most preferably all of the following properties:
(a) a density that is less than or equal to 2.41 grams/cm³;
(b) a liquidus viscosity that is greater than or equal to 100,000 poise;
(c) a strain point that is greater than or equal to 650° C.;
(d) a linear coefficient of thermal expansion (CTE) over the temperature range 0-300° C. which satisfies the relationship:

28×10⁻⁷/° C.≦CTE≦34×10⁻⁷/° C.

A fourth representative alkali-free aluminosilicate glass composition range from which touchscreen substrate articles can be fabricated is found with the alkaline earth aluminoborosilicate glasses which are substantially free of alkalis and are comprised of the following composition: (1) at least 55 mol % SiO₂: (2) at least 5 mol % Al₂O₃; (3) at least one alkaline earth RO; (4) an Al₂O₃+B₂O₃ to RO mol % ratio which exceeds 1; and, (4) an Al₂O₃ to RO mol % ratio which exceeds 0.65. The aluminoborosilicate glasses disclosed herein additionally exhibit the following properties: (1) a Vickers crack initiation load which is greater than 1000 gf; (2) a scratch resistance of at least 900 gf, as measured by the lack of the presence of lateral cracks when a load is applied by a moving Knoop indenter; (3) a Young's modulus value <75 GPa; (4) a molar volume >27.5 cm3/mol. These glasses further exhibit a linear coefficient of thermal expansion (CTE) over the temperature range 0-300° C. which satisfies the relationship: 25×10-7/° C.≦CTE≦40×10-7/° C.

According to a another embodiment, the alkaline earth aluminioborosilcate glass comprises: 55-75 mol % SiO₂, 8-15 mol % Al₂O₃, 10-20 mol % B₂O₃; 0-8% MgO, 0-8 mol % CaO, 0-8 mol % SrO and 0-8 mol % BaO.

A still further embodiment of this alkaline earth aluminoborosilicate glass comprises: 59-64 mol % SiO2; 8-12 mol % Al2O3; 11-19 mol % B2O3; mol % , 2-7% MgO, 1-8 mol % CaO, 1-6 mol % SrO and 0-6 mol % BaO.

### EXAMPLES

### Examples 1-10

Specific representative examples which can particularly formed into touchscreen substrates, which are found from each of the first two aforementioned alkali-free aluminosilicate glass compositional ranges are specifically provided in Table I. In particular, Table I lists examples of the glasses of the invention and comparative glasses in terms of mole percents which are either calculated on an oxide basis from the glass batches in the case of the crucible melts or determined from measurements on the finished glass for the compositions prepared using the continuous melter (see below). Table I also lists various physical properties for these glasses, the units for these properties being as follows:

| | |
|---|---|
| Density | grams/centimeter³ |
| CTE | ×10⁻⁷/° C. (0-300° C.) |
| Strain Point | ° C. |
| Young's Modulus | ×10⁺⁶ psi |
| Melting Temp. | ° C. |
| Liquidus Temp. | ° C. |
| Liquidus Viscosity | poises |

Inasmuch as the sum of the individual constituents totals or very closely approximates 100, for all practical purposes the reported values may be deemed to represent mole percent. The actual batch ingredients may comprise any materials, either oxides, or other compounds, which, when melted together with the other batch components, will be converted into the desired oxide in the proper proportions. For example, SrCO₃ and CaCO₃ can provide the source of SrO and CaO, respectively.

The specific batch ingredients used to prepare the glasses of Table 1 were fine sand, alumina, boric acid, magnesium oxide, limestone, strontium carbonate or strontium nitrate, and tin oxide

For examples 1-10 listed in Table I, the melting was done in a laboratory scale, continuous, Joule-heated melter. Batches of the raw materials massing 45.4 kg were weighed into a mechanical mixer and combined together for five minutes. An amount of water corresponding to about 0.25 kg was added to the mixture during the last 60 seconds of mixing to reduce dust generation. The mixture was loaded using a screw feeder into a ceramic-lined furnace with tin oxide electrodes and opposing burners firing over the melt surface. The power supplied by the electrodes was controlled by keeping the glass at a near-constant resistivity, corresponding to temperatures between 1590° C. and 1610° C. The glass moved from the melter into a platinum-based conditioning system consisting of a high-temperature finer followed by a stir chamber. The finer and stir chamber temperatures were kept constant throughout the experiment, whereas the melt temperature of the ceramic-lined melter was allowed to vary with composition. The glass drained out of the stir chamber through a heated orifice and was rolled into a ribbon approximately 5 mm thick and 30 mm wide. The glass from the ribbon was analyzed periodically for defects, which were identified, counted, and converted to defects per pound. Compositions were obtained from the ribbon via standard chemical methods, and physical properties were obtained as described below.

The glass properties set forth in Table 1 were determined in accordance with techniques conventional in the glass art. Thus, the linear coefficient of thermal expansion (CTE) over the temperature range 0-300° C. is expressed in terms of x 10⁻⁷/° C. and the strain point is expressed in terms of ° C. These were determined from fiber elongation techniques (ASTM references E228-85 and C336, respectively). The density in terms of grams/cm³ was measured via the Archimedes method (ASTM C693). The melting temperature in terms of ° C. (defined as the temperature at which the glass melt demonstrates a viscosity of 200 poises) was calculated employing a Fulcher equation fit to high temperature viscosity data measured via rotating cylinders viscometry (ASTM C965-81). The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. The liquidus viscosity in poises was determined from the liquidus temperature and the coefficients of the Fulcher equation. Young's modulus values in terms of Mpsi were determined using a resonant ultrasonic spectroscopy technique of the general type set forth in ASTM E1875-00e1.

TABLE I

| Composition | | | | | |
|---|---|---|---|---|---|
| (mol %) | 1 | 2 | 3 | 4 | 5 |
| SiO₂ | 69.06 | 68.64 | 68.01 | 68.46 | 69.28 |
| Al₂O₃ | 10.23 | 10.46 | 10.66 | 10.49 | 10.18 |
| B₂O₃ | 9.97 | 9.90 | 10.11 | 9.99 | 9.79 |
| MgO | 1.87 | 1.82 | 1.84 | 1.84 | 1.85 |
| CaO | 8.31 | 8.62 | 8.71 | 8.66 | 8.34 |
| SrO | 0.49 | 0.49 | 0.60 | 0.49 | 0.49 |
| SnO₂ | 0.07 | 0.07 | 0.07 | 0.07 | 0.07 |
| Σ[RO]/[Al₂O₃] | 1.04 | 1.04 | 1.05 | 1.05 | 1.05 |
| Properties | | | | | |
| Density | 2.369 | 2.374 | 2.378 | 2.375 | 2.369 |
| CTE | 31.2 | 31.5 | 32.3 | 31.5 | 31.1 |
| Strain Point | 665 | 664 | 667 | 666 | 666 |
| Young's | — | — | — | — | — |
| Modulus | | | | | |
| Melting | 1637 | 1624 | 1616 | 1619 | 1644 |
| Temp. | | | | | |
| Liquidus | 1130 | 1115 | 1130 | 1120 | 1145 |
| Temp. | | | | | |
| Liquidus | 360000 | 408000 | 275000 | 363000 | 233000 |
| Viscosity | | | | | |
| Composition | | | | | |
| (mol %) | 6 | 7 | 8 | 9 | 10 |
| SiO₂ | 69.08 | 68.88 | 69.11 | 68.52 | 67.80 |
| Al₂O₃ | 10.23 | 10.37 | 10.17 | 10.43 | 10.83 |
| B₂O₃ | 9.88 | 9.79 | 9.96 | 10.01 | 9.90 |
| MgO | 1.88 | 1.96 | 2.22 | 1.21 | 2.18 |
| CaO | 8.37 | 8.45 | 7.96 | 9.25 | 8.74 |
| SrO | 0.49 | 0.48 | 0.51 | 0.51 | 0.48 |
| SnO₂ | 0.07 | 0.07 | 0.07 | 0.07 | 0.07 |
| Σ[RO]/[Al₂O₃] | 1.05 | 1.05 | 1.05 | 1.05 | 1.05 |
| Properties | | | | | |
| Density | 2.371 | 2.375 | 2.367 | 2.371 | 2.384 |
| CTE | 31.2 | 31.8 | 31.1 | 32.2 | 32.1 |
| Strain Point | 665 | 668 | 664 | 665 | 667 |
| Young's | — | — | — | — | — |
| Modulus | | | | | |
| Melting | 1621 | 1630 | 1634 | 1627 | 1612 |
| Temp. | | | | | |
| Liquidus | 1135 | 1120 | 1115 | 1115 | 1120 |
| Temp. | | | | | |
| Liquidus | 243000 | 408000 | 481000 | 448000 | 330000 |
| Viscosity | | | | | |

### Examples 11-23

Specific representative examples which can particularly formed into touchscreen substrates, which are found from the fourth aforementioned alkali-free alumino silicate glasses, specifically the alkaline earth boroaluminosilicate glass compositional ranges mentioned above, are specifically provided in Table II. In particular Table II lists 13 alkali-free/alkaline earth aluminoborosilicate glasses within the claimed compositional and damage resistance scope described herein.

Inasmuch as the sum of the individual constituents totals or very closely approximates 100, for all practical purposes the reported values may be deemed to represent mole percent. The actual batch ingredients may comprise any materials, either oxides, or other compounds, which, when melted together with the other batch components, will be converted into the desired oxide in the proper proportions. For example, SrCO₃ and CaCO₃ can provide the source of SrO and CaO, respectively.

The specific batch ingredients used to prepare the glasses of Table II were fine sand, alumina, boric acid, magnesium oxide, limestone, strontium carbonate or strontium nitrate, and tin oxide

For examples 11-23 listed in Table II, and, the melting was done in a laboratory scale, continuous, Joule-heated melter. Batches of the raw materials massing 45.4 kg were weighed into a mechanical mixer and combined together for five minutes. An amount of water corresponding to about 0.25 kg was added to the mixture during the last 60 seconds of mixing to reduce dust generation. The mixture was loaded using a screw feeder into a ceramic-lined furnace with tin oxide electrodes and opposing burners firing over the melt surface. The power supplied by the electrodes was controlled by keeping the glass at a near-constant resistivity, corresponding to temperatures between 1590° C. and 1610° C. The glass moved from the melter into a platinum-based conditioning system consisting of a high-temperature finer followed by a stir chamber. The finer and stir chamber temperatures were kept constant throughout the experiment, whereas the melt temperature of the ceramic-lined melter was allowed to vary with composition. The glasses were drained out of the stir chamber through a heated orifice and were rolled into a ribbon approximately 5 mm thick and 30 mm wide. The glass from the ribbon was analyzed periodically for defects, which were identified, counted, and converted to defects per pound. Compositions were obtained from the ribbon via standard chemical methods, and physical properties were obtained as described below.

The glass properties set forth in Table I and II were determined in accordance with techniques conventional in the glass art. Thus, the linear coefficient of thermal expansion (CTE) over the temperature range 0-300° C. is expressed in terms of x 10⁻⁷/° C. and was determined from fiber elongation technique, ASTM references E228-85. Young's modulus values in terms of Mpsi were determined using a resonant ultrasonic spectroscopy technique of the general type set forth in ASTM E1875-00e1.

TABLE II

| Composition | | | | | | |
|---|---|---|---|---|---|---|
| (mol %) | 11 | 12 | 13 | 14 | 15 | 16 |
| SiO₂ | 63.7 | 63.71 | 63.71 | 63.7 | 63.7 | 59.92 |
| Al₂O₃ | 13.18 | 11.68 | 10.18 | 8.69 | 7.19 | 9.43 |
| B₂O₃ | 11.99 | 13.48 | 14.98 | 16.48 | 17.98 | 18.31 |
| MgO | 2.2 | 2.2 | 2.21 | 2.21 | 2.21 | 2.51 |
| CaO | 5.2 | 5.2 | 5.2 | 5.19 | 5.19 | 5.82 |
| SrO | 3.59 | 3.59 | 3.59 | 3.59 | 3.59 | 3.88 |
| BaO | 0.03 | 0.03 | 0.03 | 0.03 | 0.03 | 0.03 |
| SnO₂ | 0.1 | 0.1 | 0.1 | 0.1 | 0.1 | 0.10 |
| Fe₂O₃ | 0.01 | 0.01 | 0.01 | 0.01 | 0.01 | 0.01 |
| ZrO₂ | 0.01 | 0.01 | 0.01 | 0.01 | 0.01 | 0.00 |
| Crack | 1100 | 1100 | 1100 | 1300 | 1000 | 1100 |
| Initiation | | | | | | |
| load (gf) | | | | | | |
| Molar | 27.76 | 27.80 | 27.84 | 27.87 | 27.91 | 27.90 |
| Volume | | | | | | |
| (cm_{\hat{ }3}/mol) | | | | | | |
| Young's | 73.08 | 71.02 | 68.26 | 65.50 | 63.43 | 65.50 |
| Modulus | | | | | | |
| (Gpa) | | | | | | |
| RO | 11.02 | 11.02 | 11.03 | 11.02 | 11.02 | 12.24 |
| R₂O₃ | 25.17 | 25.16 | 25.16 | 25.17 | 25.17 | 27.74 |
| RO/R₂O₃ | 0.44 | 0.44 | 0.44 | 0.44 | 0.44 | 0.44 |
| R₂O₃/RO | 2.28 | 2.28 | 2.28 | 2.28 | 2.28 | 2.27 |
| Al₂O₃/RO | 1.20 | 1.06 | 0.92 | 0.79 | 0.65 | 0.77 |

| Composition | | | | | | | |
|---|---|---|---|---|---|---|---|
| (mol %) | 17 | 18 | 19 | 20 | 21 | 22 | 23 |
| SiO₂ | 63.91 | 63.91 | 63.90 | 63.90 | 63.92 | 63.91 | 63.92 |
| Al₂O₃ | 8.49 | 8.49 | 8.48 | 8.49 | 8.49 | 8.49 | 8.49 |
| B₂O₃ | 16.48 | 16.48 | 16.48 | 16.48 | 16.48 | 16.48 | 16.48 |
| MgO | 4.25 | 6.25 | 3.25 | 4.25 | 0.25 | 2.25 | 1.24 |
| CaO | 3.24 | 1.25 | 3.25 | 1.25 | 7.24 | 7.25 | 7.24 |
| SrO | 3.49 | 3.49 | 4.50 | 5.49 | 3.49 | 1.50 | 2.50 |
| BaO | 0.03 | 0.03 | 0.03 | 0.04 | 0.03 | 0.01 | 0.02 |
| SnO₂ | 0.10 | 0.10 | 0.10 | 0.10 | 0.10 | 0.10 | 0.10 |
| Fe₂O₃ | 0.01 | 0.01 | 0.01 | 0.01 | 0.01 | 0.01 | 0.01 |
| ZrO₂ | 0.00 | 0.00 | 0.00 | 0.00 | 0.00 | 0.00 | 0.00 |
| Crack | 1300 | 1300 | 1200 | 1200 | 1100 | 1000 | 1100 |
| Initiation | | | | | | | |
| load (gf) | | | | | | | |
| Molar | 27.78 | 27.72 | 27.83 | 27.82 | 27.92 | 27.80 | 27.86 |
| Volume | | | | | | | |
| (cm_{\hat{ }3}/mol) | | | | | | | |
| Young's | 66.19 | 66.88 | 65.50 | 65.50 | 64.81 | 66.19 | 65.50 |
| Modulus | | | | | | | |
| (Gpa) | | | | | | | |
| RO | 11.01 | 11.02 | 11.03 | 11.03 | 11.01 | 11.01 | 11 |
| R₂O₃ | 24.97 | 24.97 | 24.96 | 24.97 | 24.97 | 24.97 | 24.97 |
| RO/R₂O₃ | 0.44 | 0.44 | 0.44 | 0.44 | 0.44 | 0.44 | 0.44 |
| R₂O₃/RO | 2.27 | 2.27 | 2.26 | 2.26 | 2.27 | 2.27 | 2.27 |
| Al₂O₃/RO | 0.77 | 0.77 | 0.77 | 0.77 | 0.77 | 0.77 | 0.77 |

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

We claim:

1. A glass article comprising an alkali-free aluminosilicate glass, the alkali-free aluminosilicate glass exhibiting:
a high damage threshold of at least 1000 gf, as measured by a lack of the presence of median/radial cracks when a load is applied to the glass using a Vickers indenter;
a scratch resistance of at least 900 gf, as measured by a lack of the presence of lateral cracks when a load is applied by a moving Knoop indenter; and
a linear coefficient of thermal expansion (CTE) over a temperature range of 0-300° C. that satisfies the relationship: 25×10⁻⁷/° C.≦CTE≦40×10⁻⁷/° C., wherein
the alkali-free aluminosilicate glass comprises B₂O₃ in an amount greater than or equal to about 11 mol % on an oxide basis to less than or equal to about 19 mol % on an oxide basis.

2. The glass article claimed in claim 1 wherein the glass exhibits a scratch resistance of at least 1500 gf, as measured by the lack of the presence of lateral cracking with a moving Knoop indenter.

3. The glass article claimed in claim 1 wherein the glass exhibits a high damage threshold of at least 1500 gf, as measured by the lack of the presence of radial cracks when a load is applied to the glass using a Vickers indenter.

4. The glass article claimed in claim 1 wherein the alkali-free aluminosilicate glass comprises B₂O₃ in an amount from greater than or equal to about 13.48 mol % on an oxide basis to less than or equal to about 19.0 mol % on an oxide basis.

5. The glass article claimed in claim 1 wherein the glass article is an alkali-free glass comprising, in mole percent on an oxide basis:
SiO₂: 64.0-71.0;
Al₂O₃: 9.0-12.0;
MgO: 1.0-3.0;
CaO: 6.0-11.5;
SrO: 0-2.0; and
BaO: 0-0.1,
wherein
(a) 1.00≦Σ[RO]/[Al₂O₃]≦1.25,
where [Al₂O₃] is the mole percent of Al₂O₃ and Σ[RO] equals the sum of the mole percents of MgO, CaO, SrO, and BaO, and
(b) the glass has at least one of the following compositional characteristics:
(i) on an oxide basis, the glass comprises at most 0.05 mole percent Sb₂O₃; and
(ii) on an oxide basis, the glass comprises at least 0.01 mole percent SnO₂.

6. The glass article claimed in claim 5 wherein the glass has a density that is less than or equal to 2.41 grams/cm³ and one or more of the following properties:
(a) a liquidus viscosity that is greater than or equal to 100,000 poise;
(b) a strain point that is greater than or equal to 650° C.; and
(c) a linear coefficient of thermal expansion (CTE) over a temperature range of 0-300° C. that satisfies the relationship:
28×10⁻⁷/° C.≦CTE≦34×10⁻⁷/° C.

7. The glass article claimed in claim 1 wherein the glass article is an alkali-free glass comprising, in mole percent on an oxide basis:
SiO₂: 64.0-71.0;
Al₂O₃: 9.0-12.0;
MgO: 1.0-3.0;
CaO: 6.0-11.5;
SrO: 0-1.0; and
BaO: 0-0.1,
wherein Σ[RO]/[Al₂O₃]≧1.00, where [Al₂O₃] is the mole percent of Al₂O₃ and Σ[RO] equals the sum of the mole percents of MgO, CaO, SrO, and BaO.

8. The glass article claimed in claim 7 wherein Σ[RO]/[Al₂O₃]≦1.25.

9. The glass article claimed in claim 7 wherein the glass has a density that is less than or equal to 2.41 grams/cm³ and has one or more of the following properties:
(a) a liquidus viscosity that is greater than or equal to 100,000 poise;
(b) a strain point that is greater than or equal to 650° C.; and
(c) a linear coefficient of thermal expansion (CTE) over a temperature range of 0-300° C. that satisfies the relationship:
28×10⁻⁷/° C.≦CTE≦34×10⁻⁷/° C.

10. The glass article claimed in claim 1 wherein the alkali-free glass is alkaline earth aluminoborosilicate glass, comprising at least 55 mol % SiO₂, at least 5 mol % Al₂O₃ and at least one alkaline earth RO component, wherein Al₂O₃ (mol % )+B₂O₃ (mol % )/RO (mol % )>1 and the Al₂O₃ (mol % )/RO (mol % )>0.65.

11. The glass article claimed in claim 10 wherein the alkaline earth aluminoborosilicate glass comprises: 55-75 mol % SiO₂; 8-15 mol % Al₂O₃; 11-19 mol % B₂O₃; 0-8 mol % MgO; 0-8 mol % CaO; 0-8 mol % SrO; and 0-8 mol % BaO.

12. The glass article claimed in claim 10 wherein the alkaline earth aluminoborosilicate glass comprises: 59-64 mol % SiO₂; 8-12 mol % Al₂O₃; 11-19 mol % B₂O₃; 2-7 mol % MgO; 1-8 mol % CaO; 1-6 mol % SrO; and 0-6 mol % BaO.

13. The glass article claimed in claim 10 wherein the aluminoborosilicate glass has a molar volume of at least 27.5 cm³/mol and exhibits a linear coefficient of thermal expansion (CTE) over a temperature range of 0-300° C. that satisfies the relationship:
25×10⁻⁷/° C.≦CTE≦40×10⁻⁷/° C.

14. The glass article claimed in claim 1 wherein the glass article is a touchscreen substrate.
